(19) United States
(12) Patent Application Publication
(10) Pub. No.: US 2024/0249037 A1
(43) Pub. Date: Jul. 25, 2024

(54) NESTING PARTS IN 2-DIMENSIONAL (2D) SHEETS BY SIMULTANEOUSLY USING MULTIPLE PIXEL DIAGRAMS

(71) Applicant: HCL Technologies Limited, New Delhi, ND (US)

(72) Inventors: YASH KUMAR DUNGERPURIA, Navi Mumbai (IN); RAJESH JEYA KRISHNAN, Navi Mumbai (IN)

(21) Appl. No.: 18/122,168

(22) Filed: Mar. 16, 2023

(30) Foreign Application Priority Data
Jan. 25, 2023 (IN) 202311005177

(51) Int. Cl. G06F 30/20; G06F 30/17

(52) U.S. Cl. CPC G06F 30/20; G06F 30/17; G06F 2113/24

(57) ABSTRACT

This disclosure relates to method and system for nesting parts in 2-dimensional (2D) sheets. The method includes receiving one or more part drawing copies of a 2D part and a sheet drawing of a 2D sheet. Further, generating sheet pixel map of sheet drawing. For each of the part drawing copies, the method further includes generating a plurality of part pixel map pairs of part drawing copy, each of the plurality of pixel map pairs includes non-superimposable pixel map and superimposable pixel map; and determining a position of the part drawing copy on sheet pixel map where part drawing of superimposable pixel map is non-overlapping with other part pixel maps on sheet pixel map. The method further includes optimizing part pixel maps using finer fitting algorithm and updating superimposable part pixel map with non-superimposable part pixel maps on sheet drawing.

### TECHNICAL FIELD

This disclosure relates generally to the field of two-dimensional packing, and more particularly to method and system for nesting parts in 2-dimensional (2D) sheets.

### BACKGROUND

Manufacturing industries produce different types of 3-dimensional (3D) and 2-dimensional (2D) objects. While manufacturing 2D objects, multiple shapes of such objects are placed on larger 2D sheets made of a raw material (such as, wood, metal, leather, textile, paper, glass, etc.). In the present state of art, nesting problems encountered in industries may require optimal nesting of a single geometric shape in multiple quantities on the 2D sheet, or that of multiple geometric shapes in multiple quantities on the 2D sheet.

In such industries, there is an application area where it is preferred that toolpaths of neighbouring parts should overlap with each other to optimize the nesting process as well as the cutting process. An example is the wood-cutting industry. It is desirous that the packing algorithms used should perform optimally as their efficiency would ultimately reduce material consumption and the overall cost of manufacturing.

However, it is observed that sometimes there is enough space to accommodate a part on the sheet but the toolpaths of the parts take up extra space on the sheet, leading to a wastage of raw material and sometimes, requirement of a whole new sheet. Existing algorithms are unable to fit the parts optimally in such situations. Therefore, there is a need in the present state of art for techniques for optimally nesting parts in 2D sheets.

### SUMMARY

In one embodiment, a method for nesting parts in 2-dimensional (2D) sheets is disclosed. In one example, the method includes receiving one or more part drawing copies corresponding to each of at least one 2D part and a sheet drawing corresponding to a 2D sheet, from a user device. The method further includes generating a sheet pixel map corresponding to the sheet drawing for each part drawing copy of the one or more part drawing copies further generating a plurality of pixel map pairs corresponding to the part drawing copy on the sheet pixel map, each of the plurality of pixel map pairs includes a non-superimposable pixel map and a superimposable pixel map. The non-superimposable pixel map comprises the part drawing and a non-superimposable associated toolpath and superimposable pixel map comprises the part drawing and a superimposable associated toolpath. The method further includes determining a position of the part drawing copy on the sheet pixel map where the part drawing in the superimposable pixel map is non-overlapping with respect to part drawings in superimposable pixel maps of remaining of the one or more part drawing copies corresponding to each of at least one 2D part. The method further includes optimizing the position of the superimposable pixel map of the part drawing copy on the sheet pixel map using a finer fitting algorithm.

In one embodiment, a system for nesting parts in 2D sheets is disclosed. In one example, the system includes a processor and a computer-readable medium communicatively coupled to the processor. The computer-readable medium store processor-executable instructions, which, on execution, cause the processor to receive one or more part drawing copies corresponding to each of at least one 2D part and a sheet drawing corresponding to a 2D sheet from a user device. The processor-executable instructions, on execution, further cause the processor to generate a sheet pixel map corresponding to the sheet drawing. The processor-executable instructions further generates a plurality of pixel map pairs corresponding to the part drawing copy on the sheet pixel map, each of the plurality of pixel map pairs includes a non-superimposable pixel map and a superimposable pixel map. The non-superimposable pixel map includes the part drawing, and a non-superimposable associated toolpath and superimposable pixel map includes the part drawing and a superimposable associated toolpath. The processor-executable instructions, on execution, further cause the processor to determine a position of the part drawing copy on the sheet pixel map where the part drawing in the superimposable pixel map is non-overlapping with respect to part drawings in superimposable pixel maps of remaining of the one or more part drawing copies corresponding to each of at least one 2D part. The system further includes optimizing the position of the superimposable pixel map of the part drawing copy on the sheet pixel map using a finer fitting algorithm.

In one embodiment, a non-transitory computer-readable medium storing computer-executable instructions for nesting parts in 2D sheets is disclosed. In one example, the stored instructions, when executed by a processor, cause the processor to perform operations including receiving, one or more part drawing copies corresponding to each of at least one 2D part and a sheet drawing corresponding to a 2D sheet from a user device. The operations further include generating a sheet pixel map corresponding to the sheet drawing for each part drawing copy of the one or more part drawing copies. For each part drawing copy of the one or more part drawing copies, the operations further include generating a plurality of pixel map pairs corresponding to the part drawing copy on the sheet pixel map, each of the plurality of pixel map pairs includes a non-superimposable pixel map and a superimposable pixel map. The non-superimposable pixel map includes the part drawing and a non-superimposable associated toolpath, and the superimposable pixel map comprises the part drawing and a superimposable associated toolpath. For each part drawing copy of the one or more part drawing copies, the operations further include determining a position of the part drawing copy on the sheet pixel map where the part drawing in the superimposable pixel map is non-overlapping with respect to part drawings in superimposable pixel maps of remaining of the one or more part drawing copies corresponding to each of at least one 2D part.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for nesting parts in 2-dimensional (2D) sheets, in accordance with some embodiments.

FIG. 2 illustrates a functional block diagram of an exemplary nesting device implemented by the exemplary system of FIG. 1, in accordance with some embodiments.

FIGS. 3A and 3B illustrate a flow diagram of an exemplary process for nesting parts in 2D sheets, in accordance with some embodiments.

FIGS. 4A and 4B illustrate nesting of two exemplary parts in a 2D sheet, in accordance with an embodiment.

FIGS. 5A and 5B illustrate nesting of two exemplary parts in a 2D sheet, in accordance with an embodiment.

FIG. 6 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

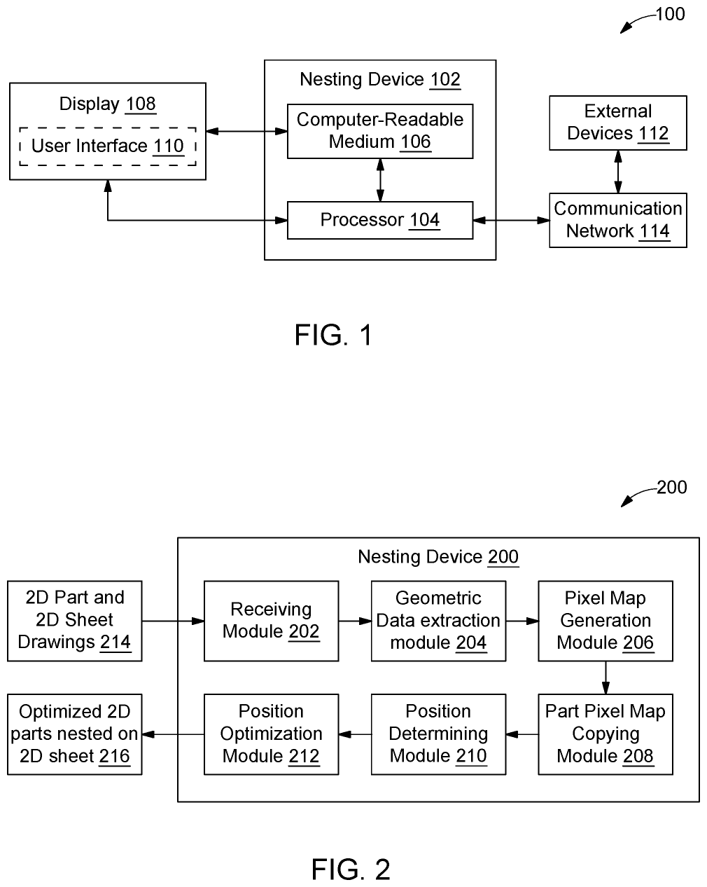

Referring now to FIG. 1, an exemplary system 100 nesting parts in 2-dimensional (2D) sheets is illustrated, in accordance with some embodiments. The system 100 may implement a nesting device 102 (for example, server, desktop, laptop, notebook, netbook, tablet, smartphone, mobile phone, or any other computing device), in accordance with some embodiments of the present disclosure. The nesting device 102 may nest parts in 2D sheets through a plurality of superimposable part pixel maps along with the toolpath.

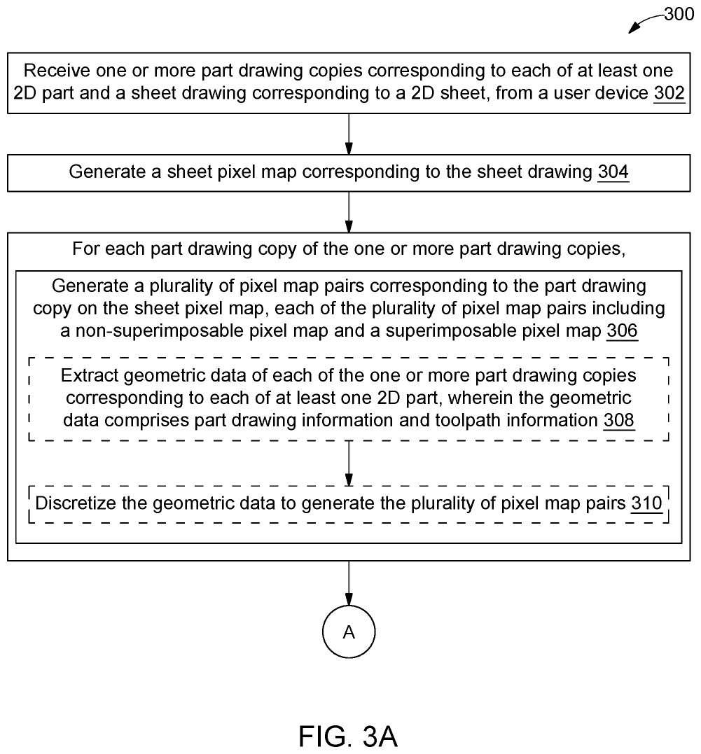

As will be described in greater detail in conjunction with FIGS. 2-6, the nesting device 102 receives one or more part drawing copies corresponding to each of at least one 2D part and a sheet drawing corresponding to a 2D sheet from a user device and extract the geometric data of the part drawings and sheet drawing including drawing information and toolpath information. The nesting device 102 further generates a sheet pixel map corresponding to the sheet drawing for each part drawing copy of the one or more part drawing copies by discretizing the geometric data. For each part drawing copy of the one or more part drawing copies, the nesting device 102 further generates a plurality of pixel map pairs corresponding to the part drawing copy on the sheet pixel map. Each of the plurality of pixel map pairs include a non-superimposable pixel map and a superimposable pixel map. The non-superimposable pixel map includes part drawing and a non-superimposable associated toolpath, and the superimposable pixel map includes the part drawing and a superimposable toolpath. For each part drawing copy of the one or more part drawing copies, the nesting device 102 further determines a position of the part drawing copy on the sheet pixel map where the part drawing in the superimposable pixel map is non-overlapping with respect to part drawings in superimposable pixel maps of remaining of the one or more part drawing copies corresponding to each of at least one 2D part by positioning the superimposable part pixel map at a unique orientation from a variety of permissible orientation on the sheet pixel map. The nesting device 102 further optimize the position of the superimposable pixel map of the part drawing copy on the sheet pixel map using a finer fitting algorithm and update the superimposable part pixel maps with non-superimposable part pixel map.

In some embodiments, the nesting device 102 may include one or more processors 104 and a computer-readable medium 106 (for example, a memory). The computer-readable medium 106 may include the database. Further, the computer-readable storage medium 106 may store instructions that, when executed by the one or more processors 104, cause the one or more processors 104 to nest parts in 2D sheets, in accordance with aspects of the present disclosure. The computer-readable storage medium 106 may also store various data (for example, geometric data of part drawings and sheet drawing, the plurality of part pixel maps, the plurality of toolpath information, sheet pixel map, and the like) that may be captured, processed, and/or required by the system 100.

The system 100 may further include a display 108. The system 100 may interact with a user via a user interface 110 accessible via the display 108. The system 100 may also include one or more external devices 112. In some embodiments, the nesting device 102 may interact with the one or more external devices 112 over a communication network 114 for sending or receiving various data. The external devices 112 may include, but may not be limited to, a remote server, a digital device, or another computing system.

Referring now to FIG. 2, functional block diagram of an exemplary nesting device 200 (analogous to the nesting device 102 implemented by the system 100) is illustrated, in accordance with some embodiments. The nesting device 200 includes a receiving module 202, a geometric data extraction module 204, a pixel map generation module 206, a part pixel map copying module 208, a position determining module 210 and, a position optimization module 212. The receiving module 202 receives 2D part and 2D sheet drawings 214 from a user device. The 2D part and 2D sheet drawings 214 include one or more part drawing copies corresponding to each of at least one 2D part and a sheet drawing corresponding to a 2D sheet. Further, the receiving module 202 sends the 2D part and 2D sheet drawings 214 to the geometric data extraction module 204. The geometric data extraction module 204 extracts the geometric data from each of the 2D part and 2D sheet drawings 214. The geometric data may include part drawing information and toolpath information. Further, the geometric data extraction module 204 sends the geometric data to the pixel map generation module 206. The pixel map generation module 206 generates a sheet pixel map using the geometric data corresponding to the sheet drawing.

Further, for each part drawing copy of the one or more part drawing copies, the pixel map generation module 206 discretizes the geometric data corresponding to the part drawing copy to generate a plurality of non-superimposable pixel maps. The discretization is critical so that geometric details are not lost, and at the same time, overall computational time is reduced. The discretization is performed by converting the part drawing into a collection of pixels or small cells. Each of the plurality of non-superimposable pixel maps includes the part drawing and a non-superimposable associated toolpath. It may be noted that each of the plurality of non-superimposable pixel maps is a simple copy representing the part drawing along with the associated toolpath. Further, the pixel map generation module 206 sends the plurality of non-superimposable pixel maps corresponding to the part drawing copy to the part pixel map copying module 208.

The part pixel map copying module 208 generates a plurality of superimposable pixel maps corresponding to the plurality of non-superimposable pixel maps. Each of the plurality of superimposable pixel maps includes the part drawing and a superimposable associated toolpath. Thus, a plurality of pixel map pairs corresponding to the part drawing copy are generated. It should be noted that each of the plurality of part pixel map pairs is positioned at a unique orientation from a plurality of permissible orientations. A pixel map pair is generated for each permissible orientation of each 2D part. Further, the part pixel map copying module 208 sends the plurality of superimposable pixel maps to the position determining module 210.

For each part drawing copy of the one or more part drawing copies, the position determining module 210 determines a position of the part drawing copy on the sheet pixel map where the part drawing in the superimposable pixel map is non-overlapping with respect to part drawings in superimposable pixel maps of remaining of the one or more part drawing copies corresponding to each of at least one 2D part. The superimposable toolpath of the part drawing copy may overlap with superimposable toolpaths of remaining of the one or more part drawing copies corresponding to each of at least one 2D part, if required. The position determining module 210 searches for a location to fit a specific orientation of the part drawing along with the associated toolpath on the available space in the sheet drawing using the superimposable part pixel map and the sheet pixel map. Thus, the nesting device 200 may save extra space by allowing the toolpaths of parts to overlap in nesting problems.

The position determining module 210 optimizes orientation of each of the one or more part drawing copies by computing each of a plurality of permissible orientations on the sheet pixel map. Further, the position determining module 210 determines whether the part drawing in the superimposable pixel map satisfies at least one of the following two conditions: (a) the part drawing in the superimposable pixel map overlaps with part drawings in superimposable pixel maps of remaining of the one or more part drawing copies corresponding to each of at least one 2D part, and (b) the part drawing in the superimposable pixel map overlaps with contours of the sheet pixel map. In an embodiment, the nesting device 200 establishes such scenarios as invalid orientations and/or positions of the part drawing copy.

The position determining module 210 iterates the aforementioned position determining process till an overlap-free and an intersection-free position is obtained for an orientation of the superimposable part pixel map. The position determining module 210 accounts for all the permissible orientations of a part pixel map to determine the best position of the superimposable part pixel map on the sheet pixel map. Further, the position determining module 210 sends the determined position and the orientation of the part drawing copy to the position optimization module 212.

The position optimization module 212 optimizes the position of the superimposable pixel map of the part drawing copy on the sheet pixel map using a finer fitting algorithm to obtain an optimal position of the superimposable pixel map. The position optimization module 212 may use a packing efficiency that is dependable on part geometry, permissible orientations, and part toolpath. The packing efficiency is mathematically represented as the following equation:

Packing Efficiency=Max[f(geometry, orientation, interval, sheet dimensions)] (1)

Further, the position optimization module 212 updates the position of the non-superimposable pixel map of the part drawing copy on the sheet pixel map in accordance with the optimal position of the superimposable pixel map.

In an embodiment, the position optimization module 212 closely packs the superimposable part pixel maps in the available space in the sheet pixel map. The final position is the location where the selected orientation of the superimposable part pixel map shares the associated superimposable toolpath with the superimposable toolpaths of one or more of neighbouring superimposable pixel maps on the sheet pixel map. Further the sheet pixel map is updated with the sheet drawing to obtain optimized 2D parts nested on the 2D sheet 216.

It should be noted that all such aforementioned modules 202-212 may be represented as a single module or a combination of different modules. Further, as will be appreciated by those skilled in the art, each of the modules 202-212 may reside, in whole or in parts, on one device or multiple devices in communication with each other. In some embodiments, each of the modules 202-212 may be implemented as dedicated hardware circuit comprising custom application-specific integrated circuit (ASIC) or gate arrays, off-the-shelf semiconductors such as logic chips, transistors, or other discrete components. Each of the modules 202-212 may also be implemented in a programmable hardware device such as a field programmable gate array (FPGA), programmable array logic, programmable logic device, and so forth. Alternatively, each of the modules 202-212 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for nesting parts in 2D sheets. For example, the exemplary system 100 and the associated nesting device 102 may nest parts in 2D sheets by the processes discussed herein. In particular, as will be appreciated by those of ordinary skill in the art, control logic and/or automated routines for performing the techniques and steps described herein may be implemented by the system 100 and the associated nesting device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

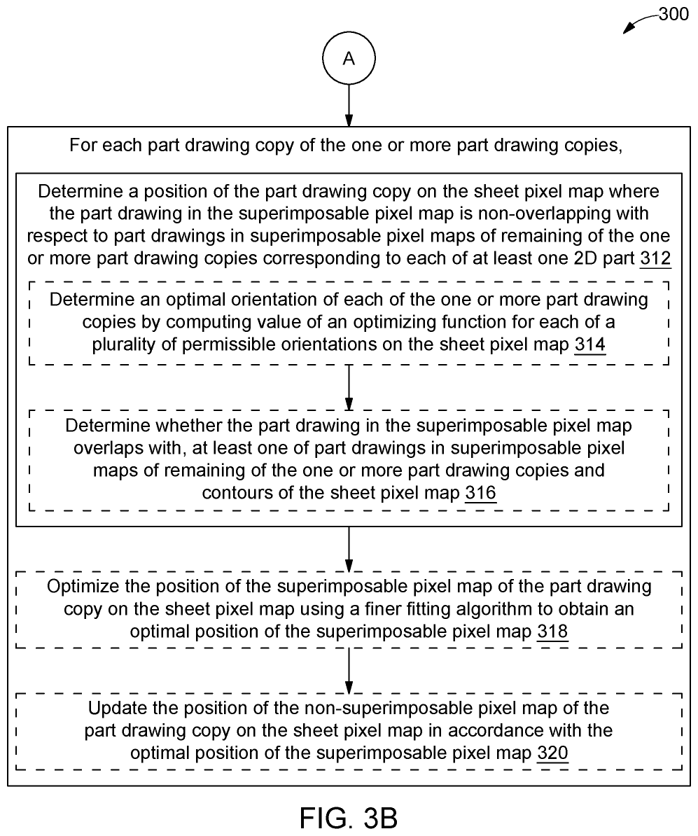

Referring now to FIGS. 3A and 3B, an exemplary process 300 for nesting parts in 2D sheets is depicted via a flowchart, in accordance with some embodiments. In an embodiment, the process 300 may be implemented by the nesting device 102 of the system 100. The process 300 includes receiving, by the receiving module 202, one or more part drawing copies corresponding to each of at least one 2D part and a sheet drawing corresponding to a 2D sheet, from a user device, at step 302. Each of the plurality of part drawings may be same or sets of different part drawings. It should be noted that shape of each of the at least one 2D part may be rectangular, circular, triangular, elliptical, polygonal, or any irregular shape. Further, the process 300 includes generating, by the pixel map generation module 206, a sheet pixel map corresponding to the sheet drawing, at step 304.

Further, for each part drawing copy of the one or more part drawing copies, the process 300 includes generating, by the pixel map generation module 206 and the part pixel map copying module 208, a plurality of pixel map pairs corresponding to the part drawing copy on the sheet pixel map, each of the plurality of pixel map pairs including a non-superimposable pixel map and a superimposable pixel map, at step 306. The non-superimposable pixel map includes the part drawing and a non-superimposable associated toolpath and, the superimposable pixel map includes the part drawing and a superimposable associated toolpath.

The step 306 of the process 300 includes extracting, by the geometric data extraction module 204, geometric data of each of the one or more part drawing copies corresponding to each of at least one 2D part, at step 308. The geometric data include part drawing information and toolpath information. Further, the step 306 of the process 300 includes discretizing, by the pixel map generation module 206, the geometric data to generate the plurality of pixel map pairs, at step 310. By way of an example, the pixel map generation module 206 may generate the non-superimposable pixel map. Further, the part pixel map copying module 208 may generate the superimposable pixel map.

Further, for each part drawing copy of the one or more part drawing copies, the process 300 includes determining, by the position determining module 210, a position of the part drawing copy on the sheet pixel map where the part drawing in the superimposable pixel map is non-overlapping with respect to part drawings in superimposable pixel maps of remaining of the one or more part drawing copies corresponding to each of at least one 2D part, at step 312. It should be noted that each of the plurality of part pixel map pairs is positioned at a unique orientation from a plurality of permissible orientations. It should also be noted that the superimposable toolpath of the part drawing copy may overlap with the superimposable toolpaths of remaining of the one or more part drawing copies corresponding to each of at least one 2D part. Therefore, the toolpaths in the superimposable pixel maps of any two part drawing copies are allowed to overlap with each other. However, the part drawings in the superimposable pixel maps of any two part drawing copies are not allowed to overlap with each other.

Further, the step 312 of the process 300 includes determining an optimal orientation of each of the one or more part drawing copies by computing value of an optimizing function for each of a plurality of permissible orientations on the sheet pixel map, at step 314. Further, the step 312 of the process 300 includes determining whether the part drawing in the superimposable pixel map overlaps with at least one of part drawings in superimposable pixel maps of remaining of the one or more part drawing copies corresponding to each of at least one 2D part, and contours of the sheet pixel map, at step 316.

Further, for each part drawing copy of the one or more part drawing copies, the process 300 includes optimizing the position of the superimposable pixel map of the part drawing copy on the sheet pixel map using a finer fitting algorithm to obtain an optimal position of the superimposable pixel map, at step 318. Further, for each part drawing copy of the one or more part drawing copies, the process 300 includes updating the position of the non-superimposable pixel map of the part drawing copy on the sheet pixel map in accordance with the optimal position of the superimposable pixel map, at step 320.

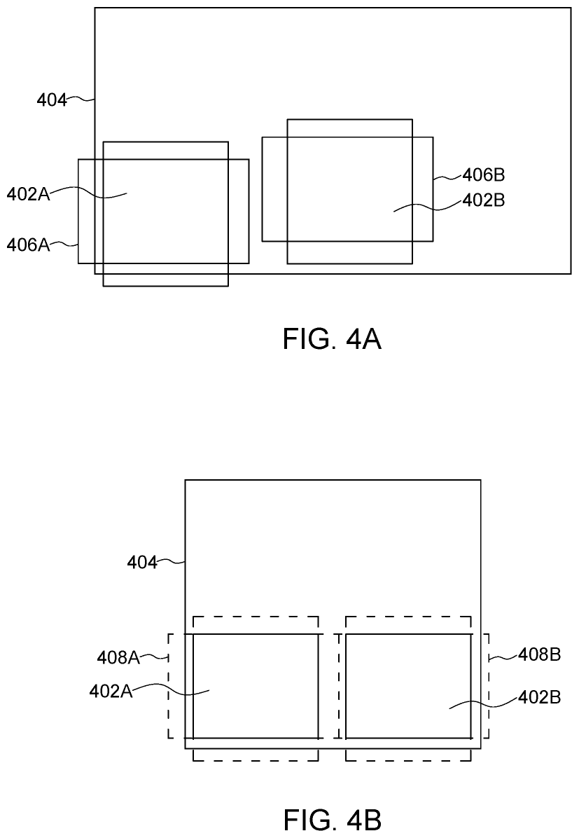

Referring now to FIGS. 4A and 4B, nesting of two exemplary parts 402a and 402b in a 2D sheet 404 is depicted, in accordance with an embodiment. In FIG. 4A, conventional algorithms generate non-superimposable pixel maps corresponding to the parts 402a and 402b. The non-superimposable pixel maps corresponding to the parts 402a and 402b include non-superimposable toolpaths 406a and 406b, respectively. The nesting of the parts 402a and 402b using the conventional algorithms requires a minimum gap between the associated non-superimposable toolpaths 406a and 406b. In other words, the non-superimposable toolpaths 406a and 406b are not allowed to overlap with each other. The space taken up by the non-superimposable toolpaths 406a and 406b on the sheet 404 is wasted as during the cutting process, the final parts do not include the toolpaths. Therefore, the nesting in such scenarios requires more area on the 2D sheet 404.

In FIG. 4B, the parts 402a and 402b are nested on the 2D sheet 404 by a nesting device (such as, the nesting device 200). Upon receiving the geometric data corresponding to the parts 402a and 402b, the pixel map generation module 206 generates a non-superimposable pixel maps corresponding to the parts 402a and 402b (similar to the non-superimposable pixel maps of FIG. 4A). Further, the part pixel map copying module 208 generates a superimposable pixel map corresponding to the parts 402a and 402b. The superimposable pixel maps corresponding to the parts 402a and 402b include superimposable toolpaths 408a and 408b, respectively. Therefore, the superimposable toolpaths 408a and 408b can overlap with each other on the sheet 404, thereby, saving some extra space. The nesting in such scenarios minimizes the space required for nesting the parts on the sheet 404. Thus, this approach is more efficient and may reduce wastage of raw material.

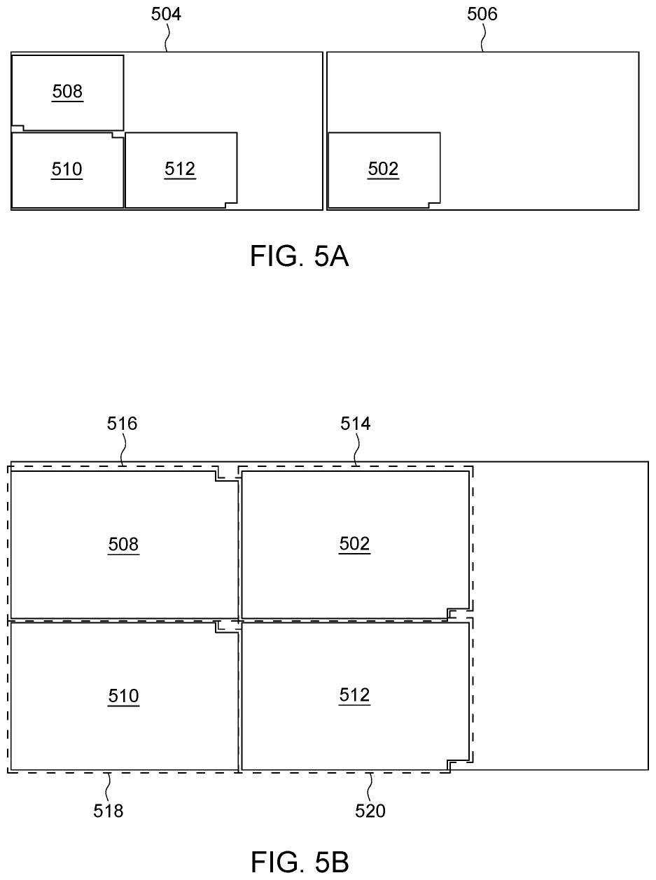

Referring now to FIGS. 5A and 5B, nesting of an exemplary part 502 in a 2D sheet 504 is depicted, in accordance with an embodiment. With reference to FIG. 5A, the 2D part 502 may be nested on a separate 2D sheet 506 despite having enough space to accommodate the part 502 on the sheet 504 along with the already nested parts 508, 510, and 512 on the 2D sheet 504, due to the non-superimposable toolpath of part 502. Thus, the remaining 2D sheet 508 is wasted just to accommodate the part 502.

In FIG. 5B, the parts 502, 508, 510, and 512 are nested on the 2D sheet 504 by a nesting device (such as, the nesting device 200). The part pixel map copying module 208 from the nesting device 200 generates the superimposable pixel maps corresponding to the parts 502, 508, 510, and 512. The superimposable pixel maps corresponding to the parts 502, 508, 510, and 512 include superimposable toolpaths 514, 516, 518, and 520, respectively. Therefore, the superimposable toolpath 514 can overlap with any of the toolpaths 520, 522, and 524, if required. Thus, in this scenario, the part 502 may be included on the 2D sheet 504, making the use of an extra 2D sheet redundant.

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

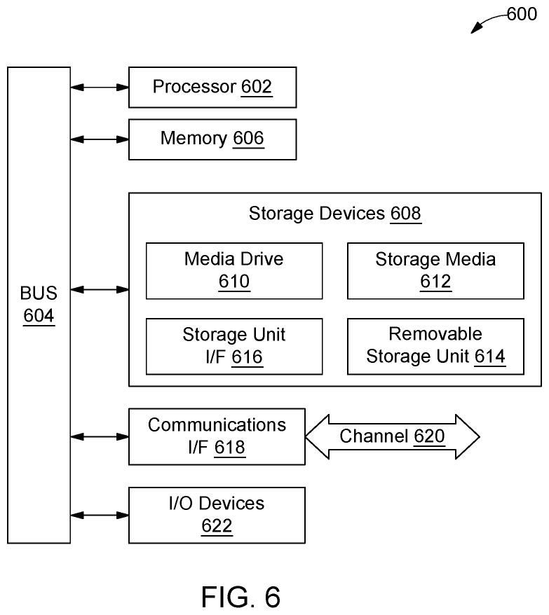

The disclosed methods and systems may be implemented on a conventional or a general-purpose computer system, such as a personal computer (PC) or server computer. Referring now to FIG. 6, an exemplary computing system 600 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 600 may represent, for example, a user device such as a desktop, a laptop, a mobile phone, personal entertainment device, DVR, and so on, or any other type of special or general-purpose computing device as may be desirable or appropriate for a given application or environment. The computing system 600 may include one or more processors, such as a processor 602 that may be implemented using a general or special purpose processing engine such as, for example, a microprocessor, microcontroller or other control logic. In this example, the processor 602 is connected to a bus 604 or other communication medium. In some embodiments, the processor 602 may be an Artificial Intelligence (AI) processor, which may be implemented as a Tensor Processing Unit (TPU), or a graphical processor unit, or a custom programmable solution Field-Programmable Gate Array (FPGA).

The computing system 600 may also include a memory 606 (main memory), for example, Random Access Memory (RAM) or other dynamic memory, for storing information and instructions to be executed by the processor 602. The memory 606 also may be used for storing temporary variables or other intermediate information during execution of instructions to be executed by the processor 602. The computing system 600 may likewise include a read only memory (“ROM”) or other static storage device coupled to bus 604 for storing static information and instructions for the processor 602.

The computing system 600 may also include a storage device 608, which may include, for example, a media drive 610 and a removable storage interface. The media drive 610 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 612 may include, for example, a hard disk, magnetic tape, flash drive, or other fixed or removable medium that is read by and written to by the media drive 610. As these examples illustrate, the storage media 612 may include a computer-readable storage medium having stored therein particular computer software or data.

In alternative embodiments, the storage devices 608 may include other similar instrumentalities for allowing computer programs or other instructions or data to be loaded into the computing system 600. Such instrumentalities may include, for example, a removable storage unit 614 and a storage unit interface 616, such as a program cartridge and cartridge interface, a removable memory (for example, a flash memory or other removable memory module) and memory slot, and other removable storage units and interfaces that allow software and data to be transferred from the removable storage unit 614 to the computing system 600.

The computing system 600 may also include a communications interface 618. The communications interface 618 may be used to allow software and data to be transferred between the computing system 600 and external devices. Examples of the communications interface 618 may include a network interface (such as an Ethernet or other NIC card), a communications port (such as for example, a USB port, a micro USB port), Near field Communication (NFC), etc. Software and data transferred via the communications interface 618 are in the form of signals which may be electronic, electromagnetic, optical, or other signals capable of being received by the communications interface 618. These signals are provided to the communications interface 618 via a channel 620. The channel 620 may carry signals and may be implemented using a wireless medium, wire or cable, fiber optics, or other communications medium. Some examples of the channel 620 may include a phone line, a cellular phone link, an RF link, a Bluetooth link, a network interface, a local or wide area network, and other communications channels.

The computing system 600 may further include Input/Output (I/O) devices 622. Examples may include, but are not limited to a display, keypad, microphone, audio speakers, vibrating motor, LED lights, etc. The I/O devices 622 may receive input from a user and also display an output of the computation performed by the processor 602. In this document, the terms “computer program product” and “computer-readable medium” may be used generally to refer to media such as, for example, the memory 606, the storage devices 608, the removable storage unit 614, or signal(s) on the channel 620. These and other forms of computer-readable media may be involved in providing one or more sequences of one or more instructions to the processor 602 for execution. Such instructions, generally referred to as “computer program code” (which may be grouped in the form of computer programs or other groupings), when executed, enable the computing system 600 to perform features or functions of embodiments of the present invention.

In an embodiment where the elements are implemented using software, the software may be stored in a computer-readable medium and loaded into the computing system 600 using, for example, the removable storage unit 614, the media drive 610 or the communications interface 618. The control logic (in this example, software instructions or computer program code), when executed by the processor 602, causes the processor 602 to perform the functions of the invention as described herein.

Thus, the disclosed method and system try to overcome the technical problem of nesting parts in 2D sheets. The method and system provide means to optimize the placement of multiple copies of rectangular or non-rectangular 2D pieces on a rectangular or non-rectangular 2D sheet of raw material. Further, the method and system optimize the nesting process as well as the cutting process. Further, the method and system may perform optimally as its efficiency would ultimately reduce material consumption and the overall cost of manufacturing. Further, the method and system fit parts where the space available in 2D sheet is not enough to accommodate the entire part along with its toolpath.

As will be appreciated by those skilled in the art, the techniques described in the various embodiments discussed above are not routine, or conventional, or well understood in the art. The techniques discussed above provide for nesting parts in 2D sheets. The techniques first receive one or more part drawing copies corresponding to each of at least one 2D part and a sheet drawing corresponding to a 2D sheet from a user device. The techniques then extract geometric data of each of the one or more part drawing copies corresponding to each of at least one 2D part. The geometric data includes part drawing information and toolpath information. The techniques then generate a sheet pixel map of the sheet drawing. For each part drawing copy of the one or more part drawing copies. The techniques then generate a plurality of pixel map pairs corresponding to the part drawing copy on the sheet pixel map, each of the plurality of pixel map pairs includes a non-superimposable pixel map and a superimposable pixel map. The techniques then determine a position of the part drawing copy on the sheet pixel map where the part drawing in the superimposable pixel map is non-overlapping with respect to part drawings in superimposable pixel maps of remaining of the one or more part drawing copies corresponding to each of at least one 2D part. The techniques then optimize the position of the superimposable pixel map of the part drawing copy on the sheet pixel map using a finer fitting algorithm and update the position of the non-superimposable pixel map of the part drawing copy on the sheet pixel map in accordance with the optimal position of the superimposable pixel map.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for nesting parts in 2D sheets. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for nesting parts in 2-dimensional (2D) sheets, the method comprising:
receiving, by a nesting device, one or more part drawing copies corresponding to each of at least one 2D part and a sheet drawing corresponding to a 2D sheet, from a user device;
generating, by the nesting device, a sheet pixel map corresponding to the sheet drawing;
for each part drawing copy of the one or more part drawing copies,
generating, by the nesting device, a plurality of pixel map pairs corresponding to the part drawing copy on the sheet pixel map, each of the plurality of pixel map pairs comprising a non-superimposable pixel map and a superimposable pixel map, wherein the non-superimposable pixel map comprises the part drawing and a non-superimposable associated toolpath, and wherein the superimposable pixel map comprises the part drawing and a superimposable associated toolpath; and
determining, by the nesting device, a position of the part drawing copy on the sheet pixel map where the part drawing in the superimposable pixel map is non-overlapping with respect to part drawings in superimposable pixel maps of remaining of the one or more part drawing copies corresponding to each of at least one 2D part.

2. The method of claim 1, wherein generating the plurality of the part pixel map pairs comprises:
extracting geometric data of each of the one or more part drawing copies corresponding to each of at least one 2D part, wherein the geometric data comprises part drawing information and toolpath information; and
discretizing the geometric data to generate the plurality of pixel map pairs.

3. The method of claim 1, further comprising:
optimizing the position of the superimposable pixel map of the part drawing copy on the sheet pixel map using a finer fitting algorithm to obtain an optimal position of the superimposable pixel map; and
updating the position of the non-superimposable pixel map of the part drawing copy on the sheet pixel map in accordance with the optimal position of the superimposable pixel map.

4. The method of claim 1, wherein each of the plurality of part pixel map pairs is positioned at a unique orientation from a plurality of permissible orientations.

5. The method of claim 4, wherein determining the position of the part drawing copy on the sheet pixel map comprises determining an optimal orientation of each of the one or more part drawing copies by computing value of an optimizing function for each of a plurality of permissible orientations on the sheet pixel map.

6. The method of claim 1, wherein determining the position of the part drawing copy on the sheet pixel map comprises determining whether the part drawing in the superimposable pixel map overlaps with, at least one of:
part drawings in superimposable pixel maps of remaining of the one or more part drawing copies corresponding to each of at least one 2D part; and
contours of the sheet pixel map.

7. A system for nesting parts in 2-dimensional (2D) sheets, the system comprising:
a processor; and
a memory communicatively coupled to the processor, wherein the memory stores processor-executable instructions, which, on execution, causes the processor to:
receive one or more part drawing copies corresponding to each of at least one 2D part and a sheet drawing corresponding to a 2D sheet, from a user device;
generate a sheet pixel map corresponding to the sheet drawing;
for each part drawing copy of the one or more part drawing copies,
generate a plurality of pixel map pairs corresponding to the part drawing copy on the sheet pixel map, each of the plurality of pixel map pairs comprising a non-superimposable pixel map and a superimposable pixel map, wherein the non-superimposable pixel map comprises the part drawing and a non-superimposable associated toolpath, and wherein the superimposable pixel map comprises the part drawing and a superimposable associated toolpath; and
determine a position of the part drawing copy on the sheet pixel map where the part drawing in the superimposable pixel map is non-overlapping with respect to part drawings in superimposable pixel maps of remaining of the one or more part drawing copies corresponding to each of at least one 2D part.

8. The system of claim 7, wherein to generate the plurality of the part pixel map pairs, the processor-executable instructions cause the processor to:
extract geometric data of each of the one or more part drawing copies corresponding to each of at least one 2D part, wherein the geometric data comprises part drawing information and toolpath information; and
discretize the geometric data to generate the plurality of pixel map pairs.

9. The system of claim 7, wherein the processor-executable instructions further cause the processor to:
optimize the position of the superimposable pixel map of the part drawing copy on the sheet pixel map using a finer fitting algorithm to obtain an optimal position of the superimposable pixel map; and
update the position of the non-superimposable pixel map of the part drawing copy on the sheet pixel map in accordance with the optimal position of the superimposable pixel map.

10. The system of claim 7, wherein each of the plurality of part pixel map pairs is positioned at a unique orientation from a plurality of permissible orientations.

11. The system of claim 10, wherein to determine the position of the part drawing copy on the sheet pixel map, the processor-executable instructions cause the processor to determine an optimal orientation of each of the one or more part drawing copies by computing value of an optimizing function for each of a plurality of permissible orientations on the sheet pixel map.

12. The system of claim 7, wherein to determine the position of the part drawing copy on the sheet pixel map, the processor-executable instructions cause the processor to determine whether the part drawing in the superimposable pixel map overlaps with, at least one of:
part drawings in superimposable pixel maps of remaining of the one or more part drawing copies corresponding to each of at least one 2D part; and
contours of the sheet pixel map.

13. A non-transitory computer-readable medium storing computer-executable instructions for nesting parts in 2-dimensional (2D) sheets, the computer-executable instructions configured for:
receiving one or more part drawing copies corresponding to each of at least one 2D part and a sheet drawing corresponding to a 2D sheet, from a user device;
generating a sheet pixel map corresponding to the sheet drawing;
for each part drawing copy of the one or more part drawing copies,
generating a plurality of pixel map pairs corresponding to the part drawing copy on the sheet pixel map, each of the plurality of pixel map pairs comprising a non-superimposable pixel map and a superimposable pixel map, wherein the non-superimposable pixel map comprises the part drawing and a non-superimposable associated toolpath, and wherein the superimposable pixel map comprises the part drawing and a superimposable associated toolpath; and
determining a position of the part drawing copy on the sheet pixel map where the part drawing in the superimposable pixel map is non-overlapping with respect to part drawings in superimposable pixel maps of remaining of the one or more part drawing copies corresponding to each of at least one 2D part.

14. The non-transitory computer-readable medium of claim 13, wherein for generating the plurality of the part pixel map pairs, the computer-executable instructions are configured for:
extracting geometric data of each of the one or more part drawing copies corresponding to each of at least one 2D part, wherein the geometric data comprises part drawing information and toolpath information; and
discretizing the geometric data to generate the plurality of pixel map pairs.

15. The non-transitory computer-readable medium of claim 13, wherein the computer-executable instructions are further configured for:
optimizing the position of the superimposable pixel map of the part drawing copy on the sheet pixel map using a finer fitting algorithm to obtain an optimal position of the superimposable pixel map; and
updating the position of the non-superimposable pixel map of the part drawing copy on the sheet pixel map in accordance with the optimal position of the superimposable pixel map.

16. The non-transitory computer-readable medium of claim 13, wherein each of the plurality of part pixel map pairs is positioned at a unique orientation from a plurality of permissible orientations.

17. The non-transitory computer-readable medium of claim 16, wherein for determining the position of the part drawing copy on the sheet pixel map, the computer-executable instructions are configured for determining an optimal orientation of each of the one or more part drawing copies by computing value of an optimizing function for each of a plurality of permissible orientations on the sheet pixel map.

18. The non-transitory computer-readable medium of claim 13, wherein for determining the position of the part drawing copy on the sheet pixel map, the computer-executable instructions are configured for determining whether the part drawing in the superimposable pixel map overlaps with, at least one of:
part drawings in superimposable pixel maps of remaining of the one or more part drawing copies corresponding to each of at least one 2D part; and
contours of the sheet pixel map.
